(19) United States
(12) Patent Application Publication
(10) Pub. No.: US 2015/0169009 A1
(43) Pub. Date: Jun. 18, 2015

(54) HINGE ASSEMBLY

(71) Applicants: Prosenjit Ghosh, Portland, OR (US); Denica N. Larsen, Hillsboro, OR (US)

(72) Inventors: Prosenjit Ghosh, Portland, OR (US); Denica N. Larsen, Hillsboro, OR (US)

(21) Appl. No.: 14/126,204

(22) PCT Filed: Jun. 28, 2013
(86) PCT No.: PCT/US2013/048699

§ 371 Date: Dec. 13, 2013

(51) Int. Cl. G06F 1/16

(52) U.S. Cl. CPC G06F 1/1681

(57) ABSTRACT

In one embodiment chassis for an electronic device comprises a first section and a second section, the second section coupled to the first section by a hinge assembly comprising a shaft, a bracket to be rotatably mounted on the shaft, a first resistance element to provide a first rotational resistance between the bracket and the shaft in a first angular range from a closed position, and a second resistance element to provide a second rotational resistance between the bracket and the shaft, greater than the first rotational resistance, in a second angular range, greater than the first angular range. Other embodiments may be described.

### BACKGROUND

The subject matter described herein relates generally to the field of electronic devices and more particularly to a locking mechanism for one or more hinge assemblies.

Some electronic devices utilize a notebook chassis. By way of example, many portable computers (e.g. traditional laptop, detachable, or convertible) and mobile electronic devices utilize a notebook chassis in which a keyboard is disposed on a first section and a display is disposed on a second section which is coupled to the first section by a hinge. Alternatively, a “clamshell” style laptop can consist of displays, e.g. at least one display on a first section and possibly one or more displays, that can also be utilized as a touch keyboard, on a second section coupled to the first section by a hinge.

Touch screen user interface is becoming increasingly common with all electronic devices, and most notably with mobile devices. In some instances, touch screen operation may cause the display to rotate due to the force applied to the screen, by the user. Locking assemblies, or at least the ability inhibit the rotation of a display on a notebook chassis may find utility.

### BRIEF DESCRIPTION OF THE DRAWINGS

The detailed description references the accompanying figures.

FIGS. 1A-1B are schematic illustrations of an exemplary electronic device which may include a hinge assembly in accordance with some embodiments.

FIGS. 2A-2E, and 3-5 are schematic illustrations of hinge assemblies in accordance with some embodiments.

FIGS. 6-10 are schematic illustrations of electronic devices which may be modified to include a hinge assembly in accordance with some embodiments.

### DETAILED DESCRIPTION

In the following description, numerous specific details are set forth to provide a thorough understanding of various embodiments. However, it will be understood by those skilled in the art that the various embodiments may be practiced without the specific details. In other instances, well-known methods, procedures, components, and circuits have not been illustrated or described in detail so as not to obscure the particular embodiments.

Described herein are exemplary systems and methods to provide resistance to the rotation of a hinge, such as may be used for a display on a notebook system chassis. In some embodiments the systems and methods described herein provide a first rotational resistance within a first angular range from a closed position and a second rotational resistance which is greater than the first rotational resistance within a second angular range. In further embodiments a third rotational resistance which is greater than the second rotational resistance is provided in a third angular range. When a hinge assembly is incorporated into an electronic device it provides a first angular range from a closed position in which a display can rotate with respect to a base of the electronic device relatively freely, a second angular range in which the display rotates with moderate friction, and a third angular range in which the display rotates with a relatively high friction and may include a spring to counter forces imparted to the display in touch screen operation. Further embodiments may include detent features which help to secure the display in fixed relation to the base.

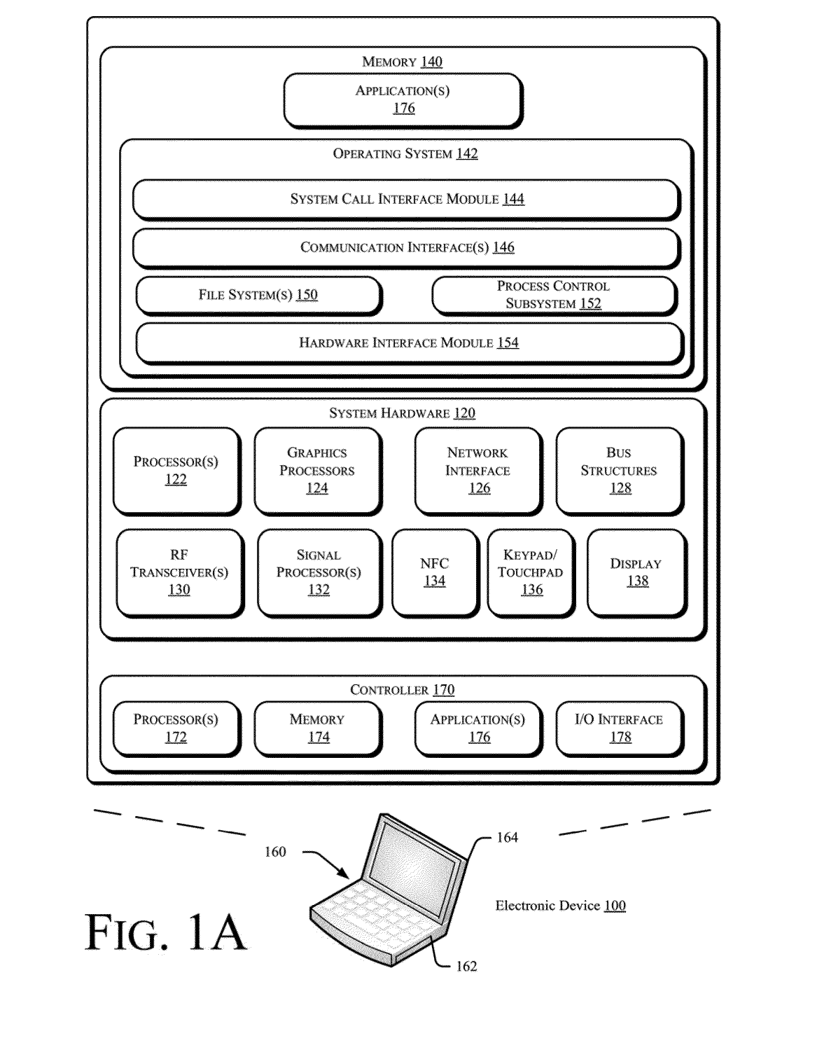

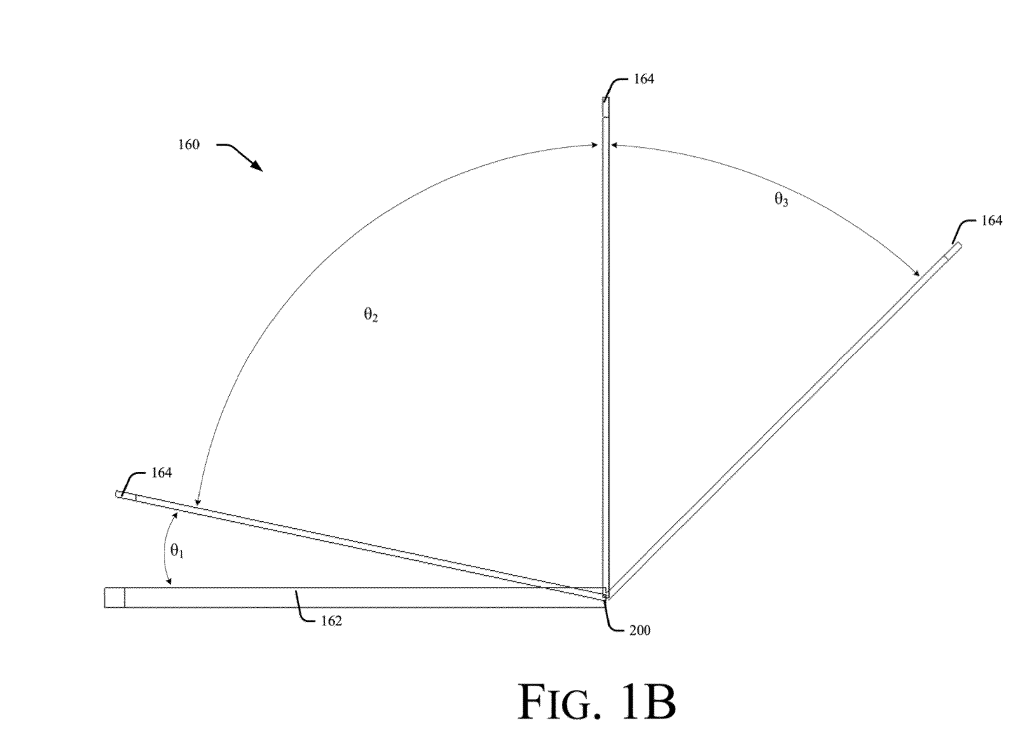

FIG. 1A is a schematic illustration of an exemplary electronic device 100 which may be adapted to include a hinge assembly which manages the rotation of a display on a notebook chassis having a first section 160 and a second section 162 in accordance with some embodiments. As illustrated in FIG. 1, electronic device 100 may be embodied as a conventional portable device such as a laptop computer, a mobile phone, tablet computer portable computer, or personal digital assistant (PDA). The particular device configuration is not critical.

In various embodiments, electronic device 100 may include or be coupled to one or more accompanying input/output devices including a display, one or more speakers, a keyboard, one or more other I/O device(s), a mouse, a camera, or the like. Other exemplary I/O device(s) may include a touch screen, a voice-activated input device, a track ball, a geolocation device, an accelerometer/gyroscope, biometric feature input devices, and any other device that allows the electronic device 100 to receive input from a user.

The electronic device 100 includes system hardware 120 and memory 140, which may be implemented as random access memory and/or read-only memory. A file store may be communicatively coupled to electronic device 100. The file store may be internal to electronic device 100 such as, e.g., eMMC, SSD, one or more hard drives, or other types of storage devices. The file store may also be external to electronic device 100 such as, e.g., one or more external hard drives, network attached storage, or a separate storage network.

System hardware 120 may include one or more processors 122, graphics processors 124, network interfaces 126, and bus structures 128. In one embodiment, processor 122 may be embodied as an Intel® Atom™ processors, Intel® Atom™ based System-on-a-Chip (SOC) or Intel® Core2 Duo® or i3/i5/i7 series processor available from Intel Corporation, Santa Clara. Calif., USA. As used herein, the term “processor” means any type of computational element, such as but not limited to, a microprocessor, a microcontroller, a complex instruction set computing (CISC) microprocessor, a reduced instruction set (RISC) microprocessor, a very long instruction word (VLIW) microprocessor, or any other type of processor or processing circuit.

Graphics processor(s) 124 may function as adjunct processor that manages graphics and/or video operations. Graphics processor(s) 124 may be integrated onto the motherboard of electronic device 100 or may be coupled via an expansion slot on the motherboard or may be located on the same die or same package as the Processing Unit.

In one embodiment, network interface 126 could be a wired interface such as an Ethernet interface (see, e.g., Institute of Electrical and Electronics Engineers/IEEE 802.3-2002) or a wireless interface such as an IEEE 802.11a, b or g-compliant interface (see, e.g., IEEE Standard for IT-Telecommunications and information exchange between systems LAN/MAN—Part II: Wireless LAN Medium Access Control (MAC) and Physical Layer (PHY) specifications Amendment 4: Further Higher Data Rate Extension in the 2.4 GHz Band, 802.11 G-2003). Another example of a wireless interface would be a general packet radio service (GPRS) interface (see. e.g., Guidelines on GPRS Handset Requirements. Global System for Mobile Communications/GSM Association, Ver. 3.0.1, December 2002).

Bus structures 128 connect various components of system hardware 128. In one embodiment, bus structures 128 may be one or more of several types of bus structure(s) including a memory bus, a peripheral bus or external bus, and/or a local bus using any variety of available bus architectures including, but not limited to, 11-bit bus, Industrial Standard Architecture (ISA). Micro-Channel Architecture (MSA), Extended ISA (EISA), Intelligent Drive Electronics (IDE). VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI), a High Speed Synchronous Serial Interface (HSI), a Serial Low-power Inter-chip Media Bus (SLIMbus®), or the like.

Electronic device 100 may include an RF transceiver 130 to transceive RF signals, a Near Field Communication (NFC) radio 134, and a signal processing module 132 to process signals received by RF transceiver 130. RF transceiver may implement a local wireless connection via a protocol such as, e.g., Bluetooth or 802.11X. IEEE 802.11a, b, g or n-compliant interface (see, e.g., IEEE Standard for IT-Telecommunications and information exchange between systems LAN/MAN—Part II: Wireless LAN Medium Access Control (MAC) and Physical Layer (PHY) specifications Amendment 4: Further Higher Data Rate Extension in the 2.4 GHz Band, 802.11 G-2003). Another example of a wireless interface would be a WCDMA, LTE, general packet radio service (GPRS) interface (see. e.g., Guidelines on GPRS Handset Requirements, Global System for Mobile Communications/GSM Association, Ver. 3.0.1, December 2002).

Electronic device 100 may further include one or more input/output interfaces such as, e.g., a keypad 136 and a display 138. In some embodiments electronic device 100 may not have a keypad and use the touch panel for input.

Memory 140 may include an operating system 142 for managing operations of electronic device 100. In one embodiment, operating system 142 includes a hardware interface module 154 that provides an interface to system hardware 120. In addition, operating system 140 may include a file system 150 that manages files used in the operation of electronic device 100 and a process control subsystem 152 that manages processes executing on electronic device 100.

Operating system 142 may include (or manage) one or more communication interfaces 146 that may operate in conjunction with system hardware 120 to transceive data packets and/or data streams from a remote source. Operating system 142 may further include a system call interface module 144 that provides an interface between the operating system 142 and one or more application modules resident in memory 130. Operating system 142 may be embodied as a UNIX operating system or any derivative thereof (e.g., Linux, Android, etc.) or as a Windows® brand operating system, or other operating systems.

In some embodiments an electronic device may include a controller 170, which may be separate from the primary execution environment. The separation may be physical in the sense that the controller may be implemented in controllers which are physically separate from the main processors. Alternatively, the separation may logical in the sense that the controller may be hosted on same chip or chipset that hosts the main processors.

By way of example, in some embodiments the controller 170 may be implemented as an independent integrated circuit located on the motherboard of the electronic device 100, e.g., as a dedicated processor block on the same S(X die. In other embodiments the controller 170 may be implemented on a portion of the processor(s) 122 that is segregated from the rest of the processor(s) using hardware enforced mechanisms

In the embodiment depicted in FIG. 1 the controller 170 comprises a processor 172, a memory module 174, a control module 176, and an I/O interface 178. In some embodiments the memory module 174 may comprise a persistent flash memory module and the various functional modules may be implemented as logic instructions encoded in the persistent memory module, e.g., firmware or software. The I/O interface 178 may comprise a serial I/O module or a parallel I/O module. Because the controller 170 is separate from the main processor(s) 122 and operating system 142, the controller 170 may be made secure, i.e., inaccessible to hackers who typically mount software attacks from the host processor 122.

In some embodiments the electronic device 100 may comprise a hinge assembly 200 which couples the first section 162 and the second section 164. As illustrated in FIG. 1B, in some embodiments the systems and methods described herein the hinge assembly 200 provides a first rotational resistance when the second section 164 is rotated within a first angular range identified by θ₁ in FIG. 1B from a resting position and a second rotational resistance which is greater than the first rotational resistance when the second section 164 is rotated in a second angular range θ₂ which is outside the first angular range. In further embodiments the hinge assembly 200 provides a third rotational resistance when the second section 164 is rotated within a third angular range identified by θ₃ in FIG. 1B.

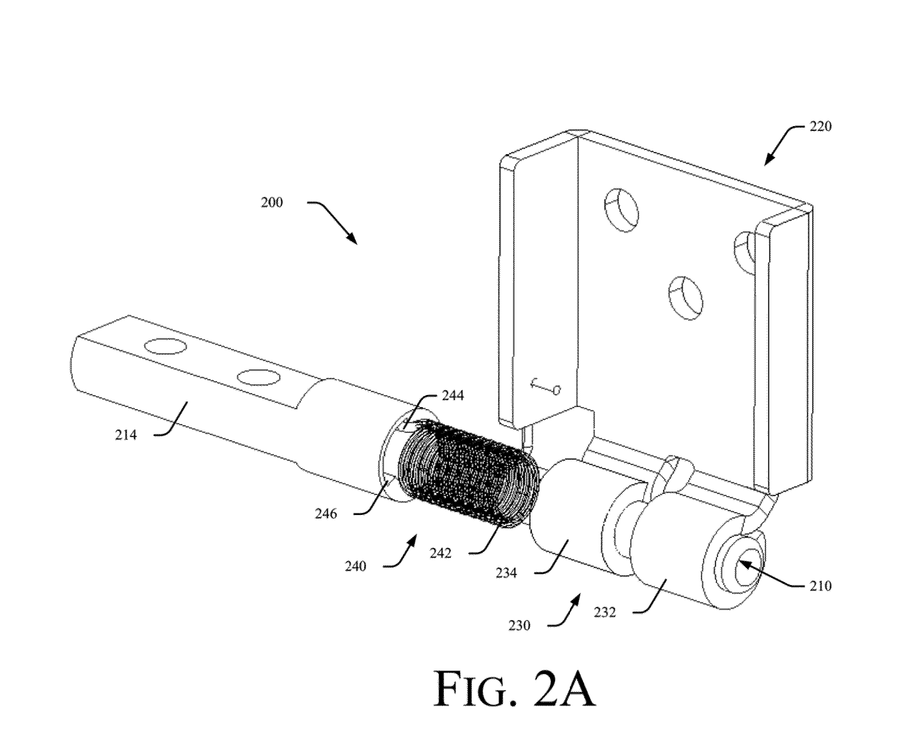

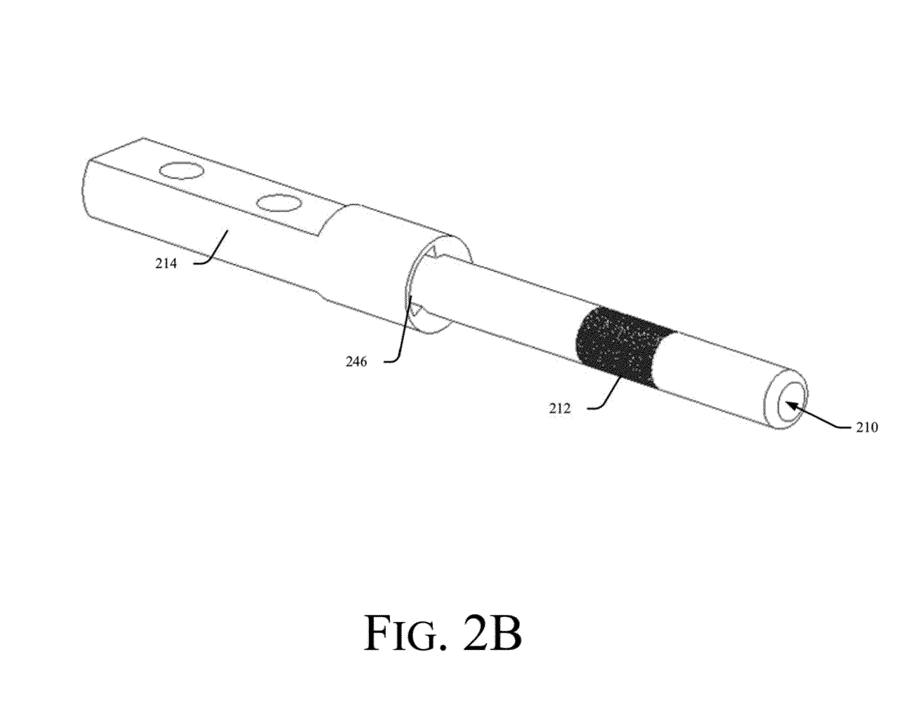

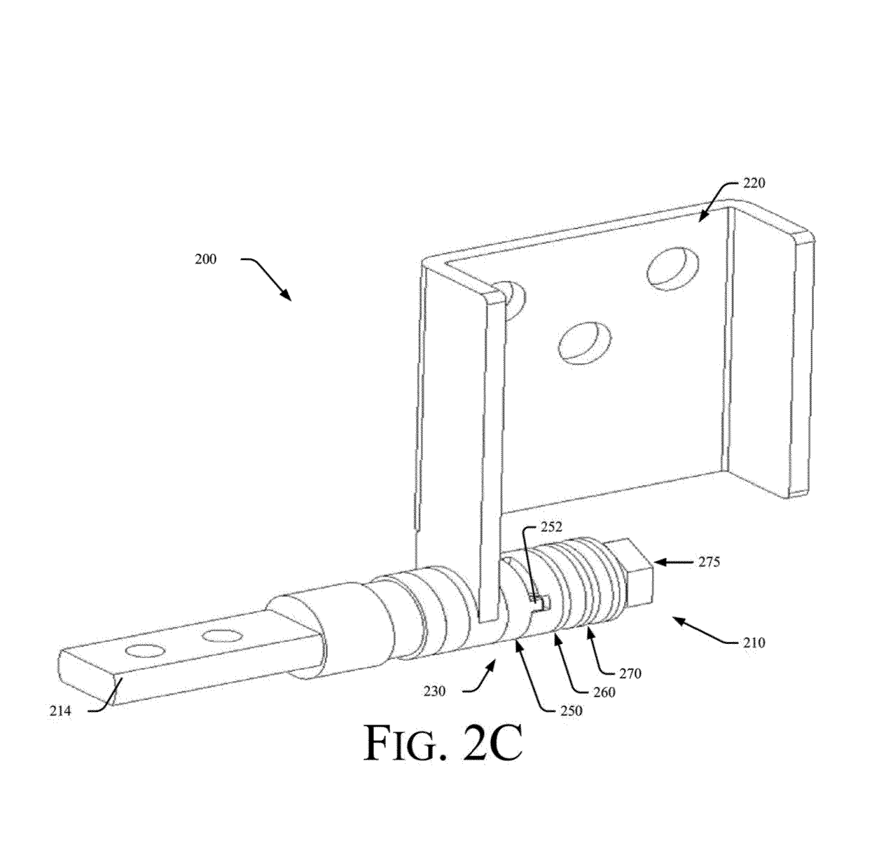

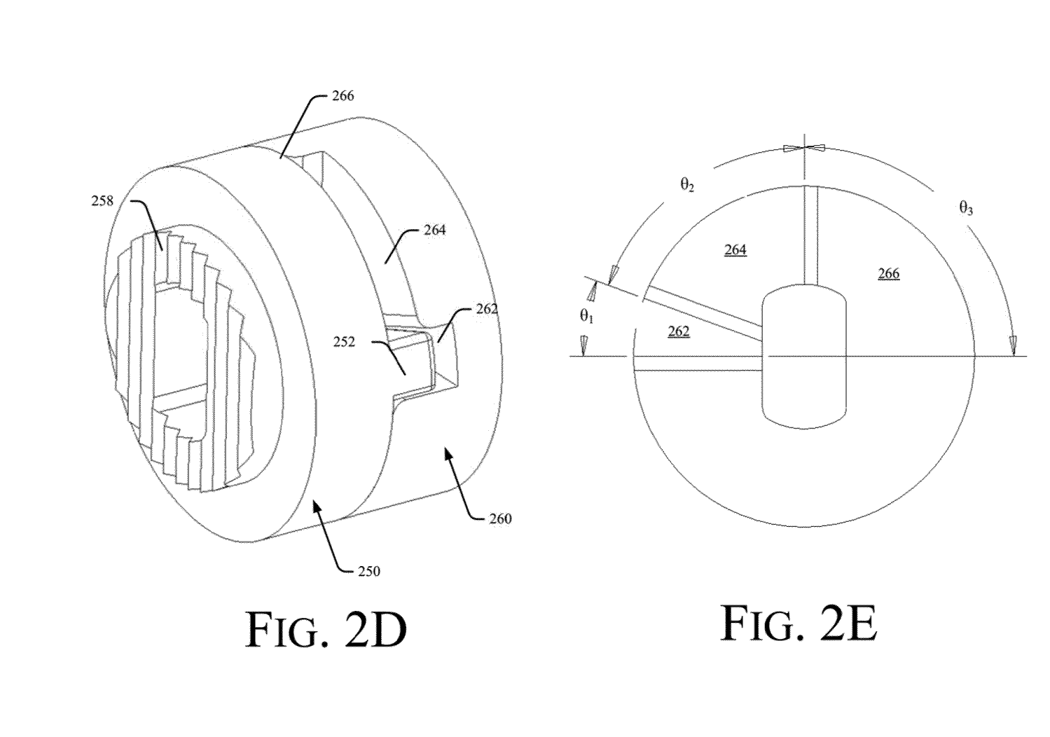

Embodiments of a hinge assembly 200 will be described with reference to FIGS. 2A-2E and 3-5. Referring first to FIGS. 2A-2B, in one embodiment a hinge assembly 200 comprises a shaft 210, a bracket 220 to be rotatably mounted on the shaft 210, a first resistance element 230 to provide a first rotational resistance between the bracket 220 and the shaft 210 in a first angular range from a closed position and a second resistance element 240 to provide a second rotational resistance between the bracket 220 and the shaft 210, greater than the first rotational resistance, in a second angular range, greater than the first angular range.

In greater detail, the shaft 210 may be coupled to a mounting brace 214 which may be secured to a the first section 162 of an electronic device 100 by suitable fixtures. Similarly, bracket 220 may be coupled to second section 164 of an electronic device 100. Thus, when fitted with one or more hinge assemblies 200, the first section 162 and second section 164 of an electronic device 100 are rotatably connected via the hinge assemblies 200. Shaft 210, base section 214, and bracket 220 may be formed from a suitably rigid material, e.g, a metal, alloy, or a suitably strong polymer material.

In some embodiments the first resistance element 230 comprises a first friction band 232 to couple the bracket 220 to the shaft 210. The first friction band 232 may be frictionally engaged with shaft 210 to generate a first rotational resistance between the bracket. In some embodiments the shaft 210 has a slightly variable radius in a region proximate the first friction band 232, such that rotation of the bracket 220 about the shaft 210 generates variable frictional engagement within different angular ranges of rotation.

In some embodiments the first resistance element 230 further comprises a second friction band 234 to couple the bracket 220 to the shaft 210. As illustrated in FIG. 2B, the shaft 210 has a knurled surface 212 in a region proximate the second friction band 234. In some embodiments damping grease is applied to the knurled surface 212 to absorb energy imparted to the second section 164 of an electronic device 100, e.g., by the use of a touch screen display or the like.

In some embodiments the second friction 240 comprises a torsion spring 242 that is mounted about shaft 210. Torsion spring 242 comprises a tab 244 that rotates within an angular range defined by a slot 246 of the base section 214. When the tab 244 rotates freely the torsion spring 242 does not absorb energy. But when the tab 244 reaches the end of the slot 246, as depicted in FIG. 2A, further rotation of the bracket 220 about the shaft causes torsion spring 242 to tighten, thereby providing a second rotational resistance to rotation between the shaft 210 and the bracket 220.

In another embodiment, a key and slot arrangement defines three different rotational resistance levels between the bracket 220 and the shaft 210. Referring to FIGS. 2C-2E, a hinge assembly 200 comprises a shaft 210 and a bracket 220 to be rotatably mounted on the shaft 210. A first disk 250 comprising a key 252 is mounted on the shaft 210 and rotatable with the bracket 220 about the shaft 210. A second disk 260 is fixedly mounted adjacent first disk 250 on the shaft 210. One or more compressible disks 270 are mounted on the shaft 210 between the first disk 250 and a nut 275.

Referring to FIGS. 2D-2E, disk 260 comprises three surfaces which impart three different levels of rotational resistance between disk 250 and disk 260. When the key 252 of disk 250 is in the slot defined by first surface 262 the key 252 and the surface 262 generate a first rotational resistance through a first angle θ₁ in FIG. 2E. When bracket 220 is rotated such that the key 252 of disk 250 slides onto surface 264 the key 252 and the surface 264 generate a second rotational resistance through a second angle θ₂ in FIG. 2E. When bracket 220 is rotated such that the key 252 of disk 250 slides onto surface 266 the key 252 and the surface 266 generate a third rotational resistance through a first angle θ₃ in FIG. 2E. Thus, the hinge assembly depicted in FIGS. 2C-2E generates three different rotational resistance values in three different angular ranges.

The specific angular ranges through which the hinge assembly provides different values of rotational resistance are not critical. In some embodiments the hinge assembly provides a first rotational resistance through a first angle θ₁ in FIG. 2E that measures approximately 12 degrees, a second rotational resistance through a second angle θ₂ in FIG. 2E that measures approximately 78 degrees, and a third rotational resistance through a third angle θ₃ in FIG. 2E that measures approximately 90 degrees. Thus, when incorporated into an electronic device 100 the hinge assembly enables three different rotational resistance values between the first section 162 and the second section 164 of the housing in different angular ranges, as illustrated in FIG. 1B.

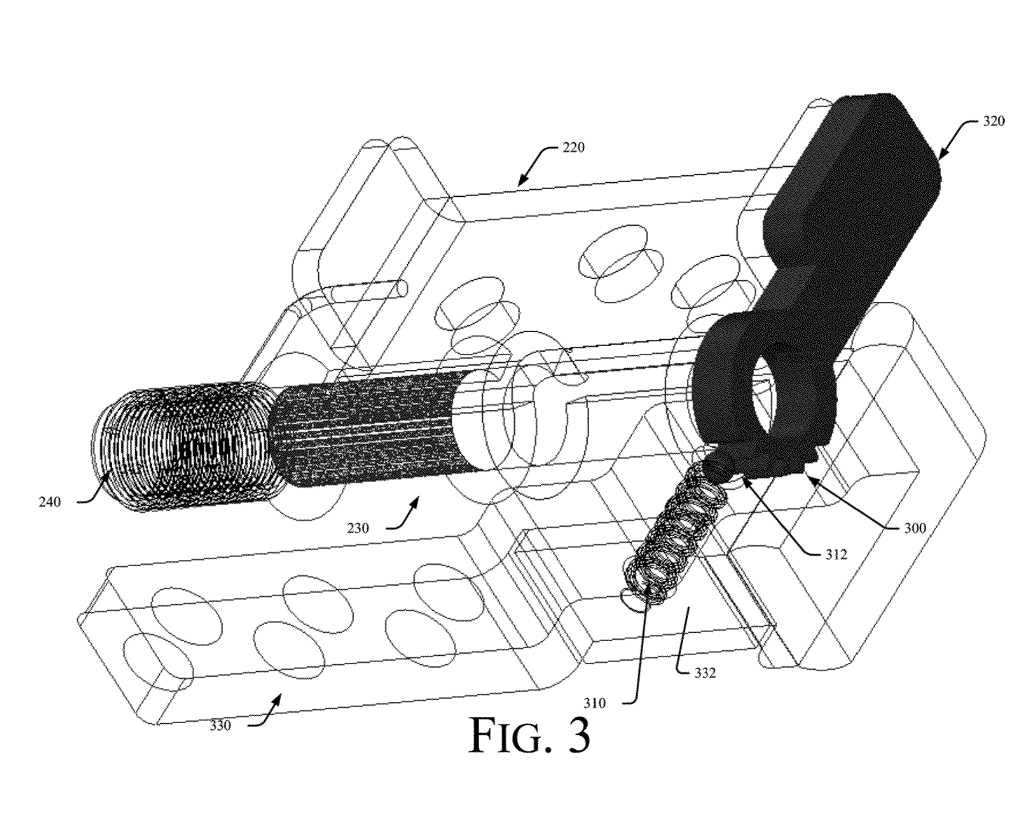

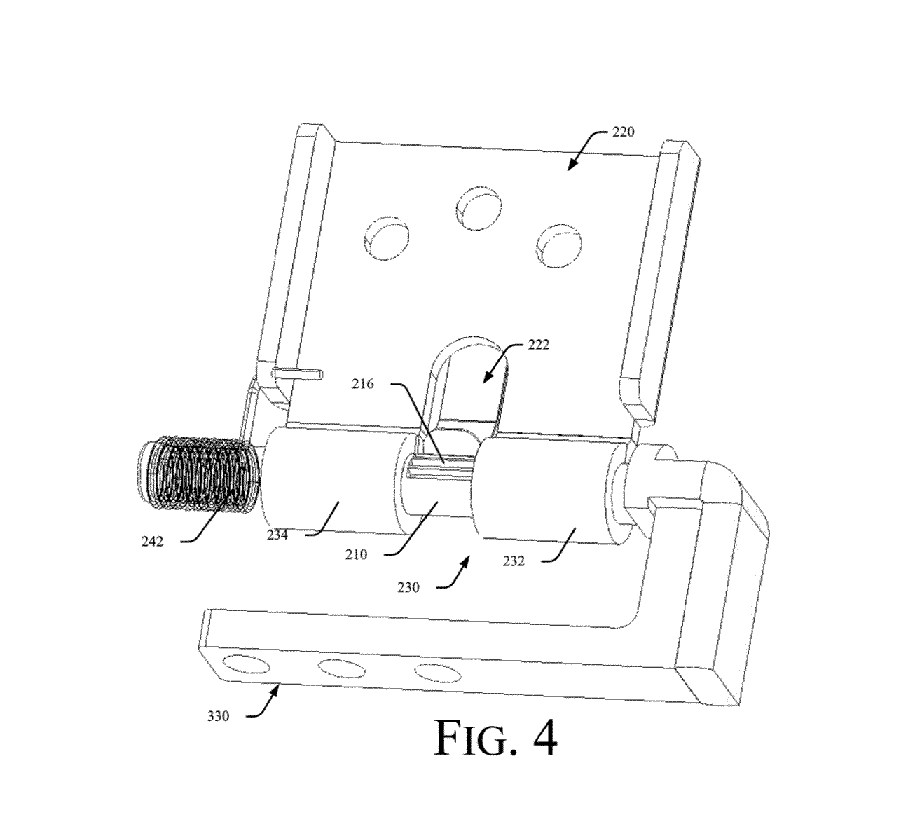

In some embodiments a hinge assembly 200 may include a locking mechanism 300 to lock the hinge assembly in a given position. Referring to FIG. 3, in some embodiments a gear member 320 is coupled to bracket 220 and includes a geared surface 322. A spring 310 is compressed between a plate 332 on bracket 330 and the gear member 320. A ball 312 coupled to spring 310 slides into the geared surface 322 to lock the bracket 220 in place until sufficient force is applied to the bracket 220 to compress the spring such that the ball 312 is displaced from the geared surface 322 to allow the bracket 220 to rotate relative to the shaft 210.

Referring to FIG. 4, in some embodiments the shaft 210 comprises a series of detents 216 formed a portion of the surface of the shaft 210 and a key 222 is coupled to the bracket 220. The key 222 slides into the detents to lock the bracket 220 in place until sufficient force is applied to the bracket 220 to force the key 222 from the detents in surface 210 to allow the bracket 220 to rotate relative to the shaft 210.

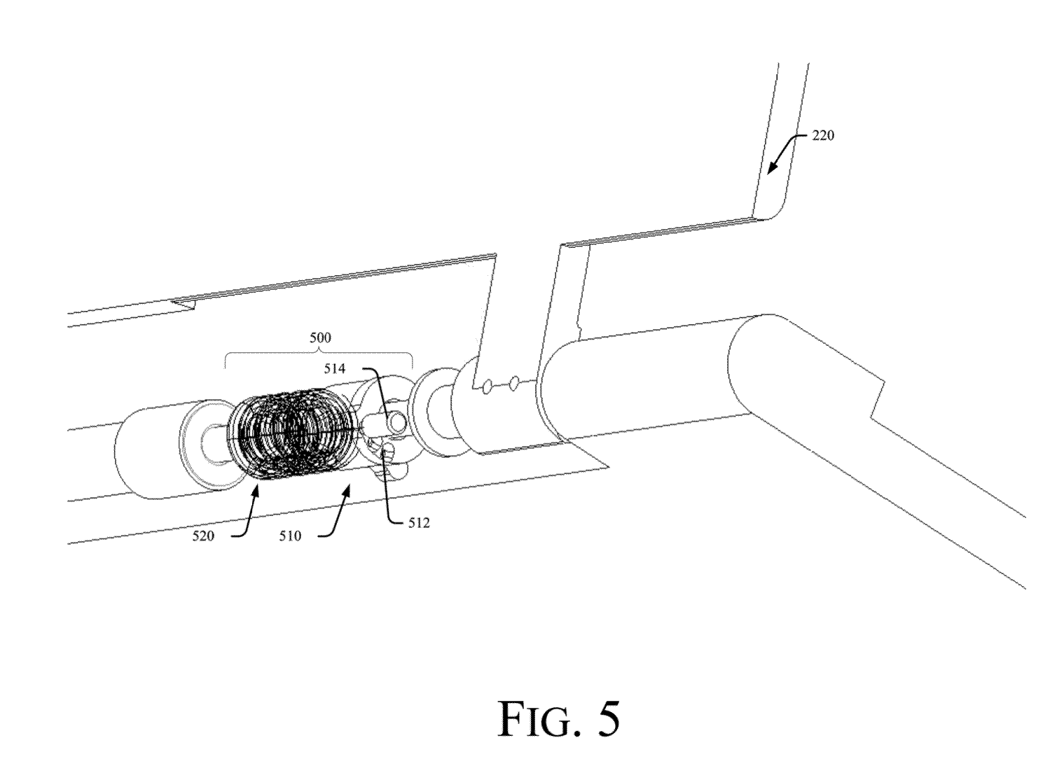

Referring to FIG. 5, in some embodiments the hinge assembly 200 comprises a detent mechanism 500 that is constructed around the shaft 210. The detent mechanism 500 comprises a cylinder 510 having a plurality of detents 512 disposed on a surface thereof. A detent spring 510 biases a plunger 514 such that the plunger 514 extends through the detents 512.

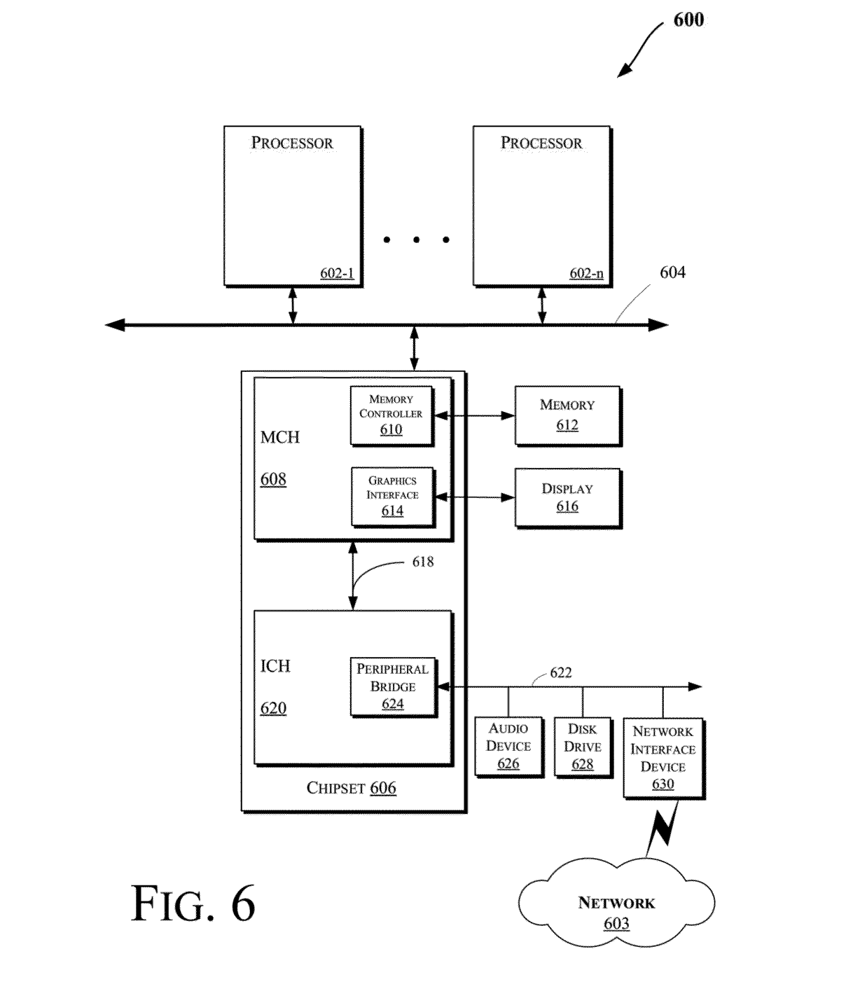

As described above, in some embodiments the electronic device may be embodied as a computer system. FIG. 6 illustrates a block diagram of a computing system 600 in accordance with an embodiment of the invention. The computing system 600 may include one or more central processing unit(s) (CPUs) 602 or processors that communicate via an interconnection network (or bus) 604. The processors 602 may include a general purpose processor, a network processor (that processes data communicated over a computer network 603), or other types of a processor (including a reduced instruction set computer (RISC) processor or a complex instruction set computer (CISC)). Moreover, the processors 602 may have a single or multiple core design. The processors 602 with a multiple core design may integrate different types of processor cores on the same integrated circuit (IC) die. Also, the processors 602 with a multiple core design may be implemented as symmetrical or asymmetrical multiprocessors. In an embodiment, one or more of the processors 602 may be the same or similar to the processors 102 of FIG. 1. For example, one or more of the processors 602 may include the control unit 120 discussed with reference to FIGS. 1-3. Also, the operations discussed with reference to FIGS. 3-5 may be performed by one or more components of the system 600.

A chipset 606 may also communicate with the interconnection network 604. The chipset 606 may include a memory control hub (MCH) 608. The MCH 608 may include a memory controller 610 that communicates with a memory 612 (which may be the same or similar to the memory 130 of FIG. 1). The memory 412 may store data, including sequences of instructions, that may be executed by the CPU 602, or any other device included in the computing system 600. In one embodiment of the invention, the memory 612 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk. Additional devices may communicate via the interconnection network 604, such as multiple CPUs and/or multiple system memories.

The MCH 608 may also include a graphics interface 614 that communicates with a display device 616. In one embodiment of the invention, the graphics interface 614 may communicate with the display device 616 via an accelerated graphics port (AGP). In an embodiment of the invention, the display 616 (such as a flat panel display) may communicate with the graphics interface 614 through, for example, a signal converter that translates a digital representation of an image stored in a storage device such as video memory or system memory into display signals that are interpreted and displayed by the display 616. The display signals produced by the display device may pass through various control devices before being interpreted by and subsequently displayed on the display 616.

A hub interface 618 may allow the MCH 608 and an input/output control hub (ICH) 620 to communicate. The ICH 620 may provide an interface to I/O device(s) that communicate with the computing system 600. The ICH 620 may communicate with a bus 622 through a peripheral bridge (or controller) 624, such as a peripheral component interconnect (PCI) bridge, a universal serial bus (USB) controller, or other types of peripheral bridges or controllers. The bridge 624 may provide a data path between the CPU 602 and peripheral devices. Other types of topologies may be utilized. Also, multiple buses may communicate with the ICH 620, e.g., through multiple bridges or controllers. Moreover, other peripherals in communication with the ICH 620 may include, in various embodiments of the invention, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 622 may communicate with an audio device 626, one or more disk drive(s) 628, and a network interface device 630 (which is in communication with the computer network 603). Other devices may communicate via the bus 622. Also, various components (such as the network interface device 630) may communicate with the MCH 608 in some embodiments of the invention. In addition, the processor 602 and one or more other components discussed herein may be combined to form a single chip (e.g., to provide a System on Chip (SOC)). Furthermore, the graphics accelerator 616 may be included within the MCH 608 in other embodiments of the invention.

Furthermore, the computing system 600 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 628), a floppy disk, a compact disk ROM (CD-ROM), a digital versatile disk (DVD), flash memory, a magneto-optical disk, or other types of nonvolatile machine-readable media that are capable of storing electronic data (e.g., including instructions).

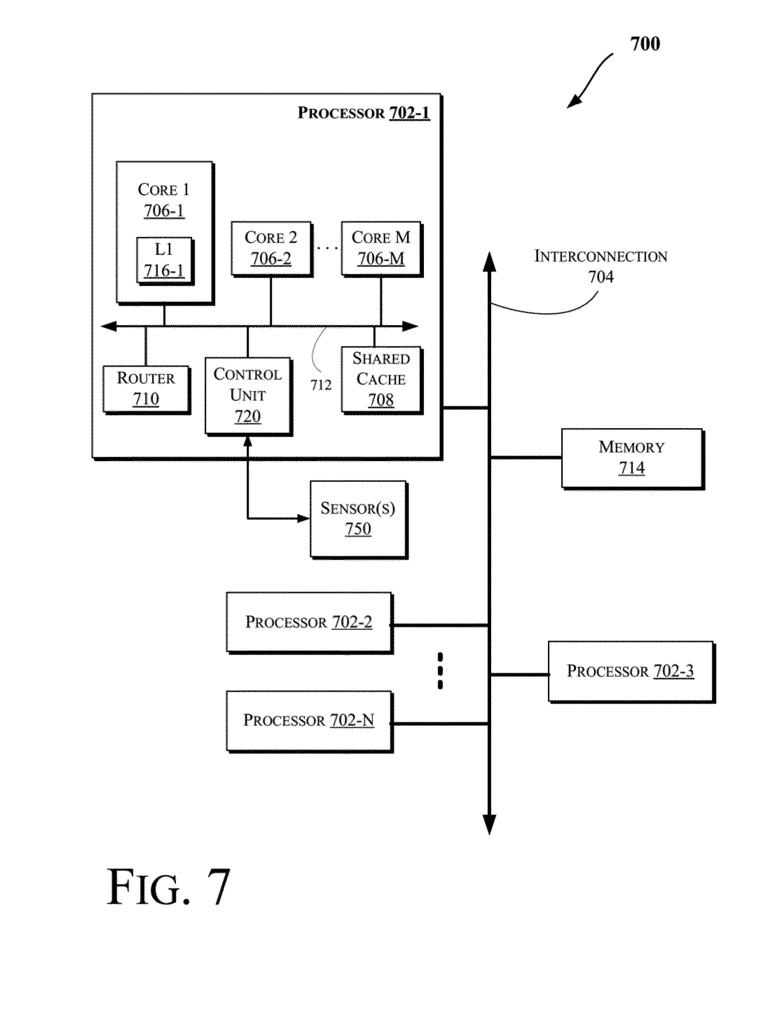

FIG. 7 illustrates a block diagram of a computing system 700, according to an embodiment of the invention. The system 700 may include one or more processors 702-1 through 702-N (generally referred to herein as “processors 702” or “processor 702”). The processors 702 may communicate via an interconnection network or bus 704. Each processor may include various components some of which are only discussed with reference to processor 702-1 for clarity. Accordingly, each of the remaining processors 702-2 through 702-N may include the same or similar components discussed with reference to the processor 702-1.

In an embodiment, the processor 702-1 may include one or more processor cores 706-1 through 706-M (referred to herein as “cores 706” or more generally as “core 706”), a shared cache 708, a router 710, and/or a processor control logic or unit 720. The processor cores 706 may be implemented on a single integrated circuit (IC) chip. Moreover, the chip may include one or more shared and/or private caches (such as cache 708), buses or interconnections (such as a bus or interconnection network 712), memory controllers, or other components.

In one embodiment, the router 710 may be used to communicate between various components of the processor 702-1 and/or system 700. Moreover, the processor 702-1 may include more than one router 710. Furthermore, the multitude of routers 710 may be in communication to enable data routing between various components inside or outside of the processor 702-1.

The shared cache 708 may store data (e.g., including instructions) that are utilized by one or more components of the processor 702-1, such as the cores 706. For example, the shared cache 708 may locally cache data stored in a memory 714 for faster access by components of the processor 702. In an embodiment, the cache 708 may include a mid-level cache (such as a level 2 (L2), a level 3 (L3), a level 4 (L4), or other levels of cache), a last level cache (LLC), and/or combinations thereof. Moreover, various components of the processor 702-1 may communicate with the shared cache 708 directly, through a bus (e.g., the bus 712), and/or a memory controller or hub. As shown in FIG. 7, in some embodiments, one or more of the cores 706 may include a level 1 (L1) cache 716-1 (generally referred to herein as “L1 cache 716”). In one embodiment, the controller 720 may include logic to implement the operations described above with reference to FIG. 3.

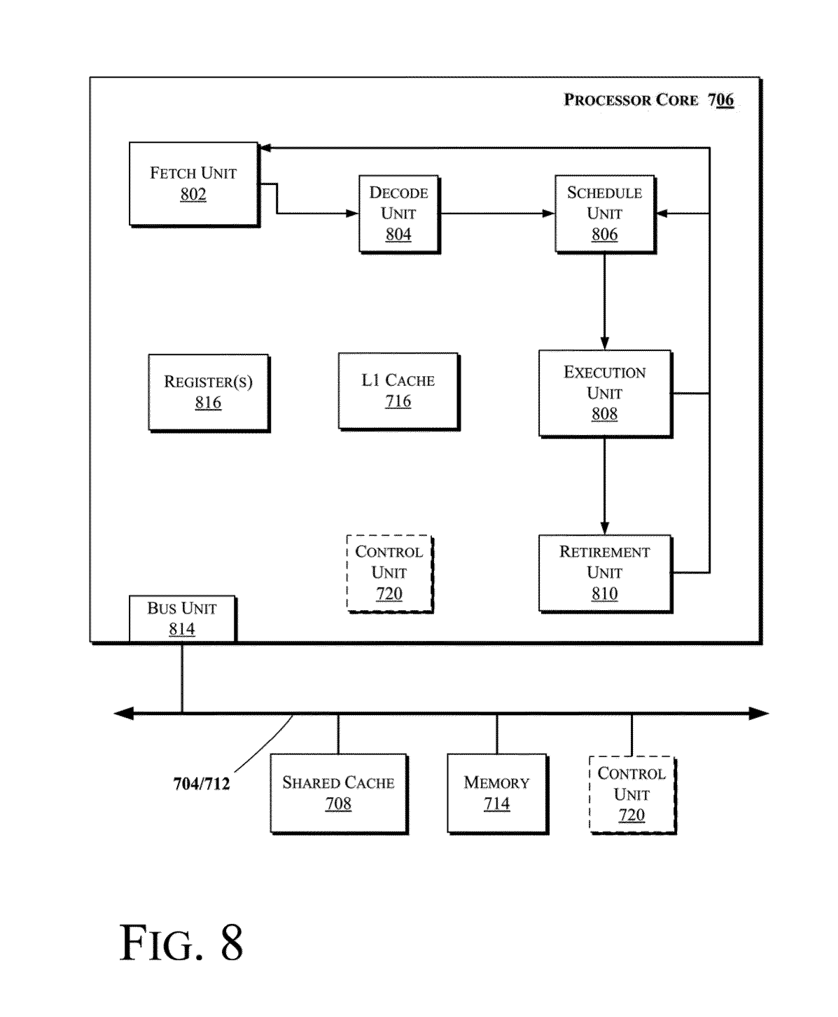

FIG. 8 illustrates a block diagram of portions of a processor core 706 and other components of a computing system, according to an embodiment of the invention. In one embodiment, the arrows shown in FIG. 8 illustrate the flow direction of instructions through the core 706. One or more processor cores (such as the processor core 706) may be implemented on a single integrated circuit chip (or die) such as discussed with reference to FIG. 7. Moreover, the chip may include one or more shared and/or private caches (e.g., cache 708 of FIG. 7), interconnections (e.g., interconnections 704 and/or 112 of FIG. 7), control units, memory controllers, or other components.

As illustrated in FIG. 8, the processor core 706 may include a fetch unit 802 to fetch instructions (including instructions with conditional branches) for execution by the core 706. The instructions may be fetched from any storage devices such as the memory 714. The core 706 may also include a decode unit 804 to decode the fetched instruction. For instance, the decode unit 804 may decode the fetched instruction into a plurality of uops (micro-operations).

Additionally, the core 706 may include a schedule unit 806. The schedule unit 806 may perform various operations associated with storing decoded instructions (e.g., received from the decode unit 804) until the instructions are ready for dispatch, e.g., until all source values of a decoded instruction become available. In one embodiment, the schedule unit 806 may schedule and/or issue (or dispatch) decoded instructions to an execution unit 808 for execution. The execution unit 808 may execute the dispatched instructions after they are decoded (e.g., by the decode unit 804) and dispatched (e.g., by the schedule unit 806). In an embodiment, the execution unit 808 may include more than one execution unit. The execution unit 808 may also perform various arithmetic operations such as addition, subtraction, multiplication, and/or division, and may include one or more an arithmetic logic units (ALUs). In an embodiment, a co-processor (not shown) may perform various arithmetic operations in conjunction with the execution unit 808.

Further, the execution unit 808 may execute instructions out-of-order. Hence, the processor core 706 may be an out-of-order processor core in one embodiment. The core 706 may also include a retirement unit 810. The retirement unit 810 may retire executed instructions after they are committed. In an embodiment, retirement of the executed instructions may result in processor state being committed from the execution of the instructions, physical registers used by the instructions being de-allocated, etc.

The core 706 may also include a bus unit 714 to enable communication between components of the processor core 706 and other components (such as the components discussed with reference to FIG. 8) via one or more buses (e.g., buses 804 and/or 812). The core 706 may also include one or more registers 816 to store data accessed by various components of the core 706 (such as values related to power consumption state settings).

Furthermore, even though FIG. 7 illustrates the control unit 720 to be coupled to the core 706 via interconnect 812, in various embodiments the control unit 720 may be located elsewhere such as inside the core 706, coupled to the core via bus 704, etc.

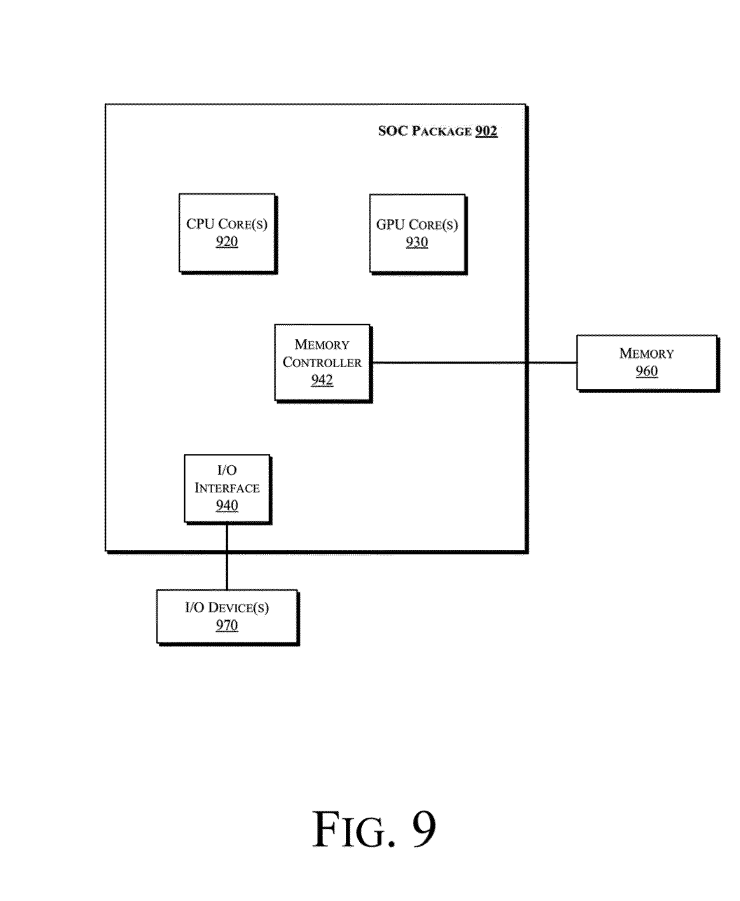

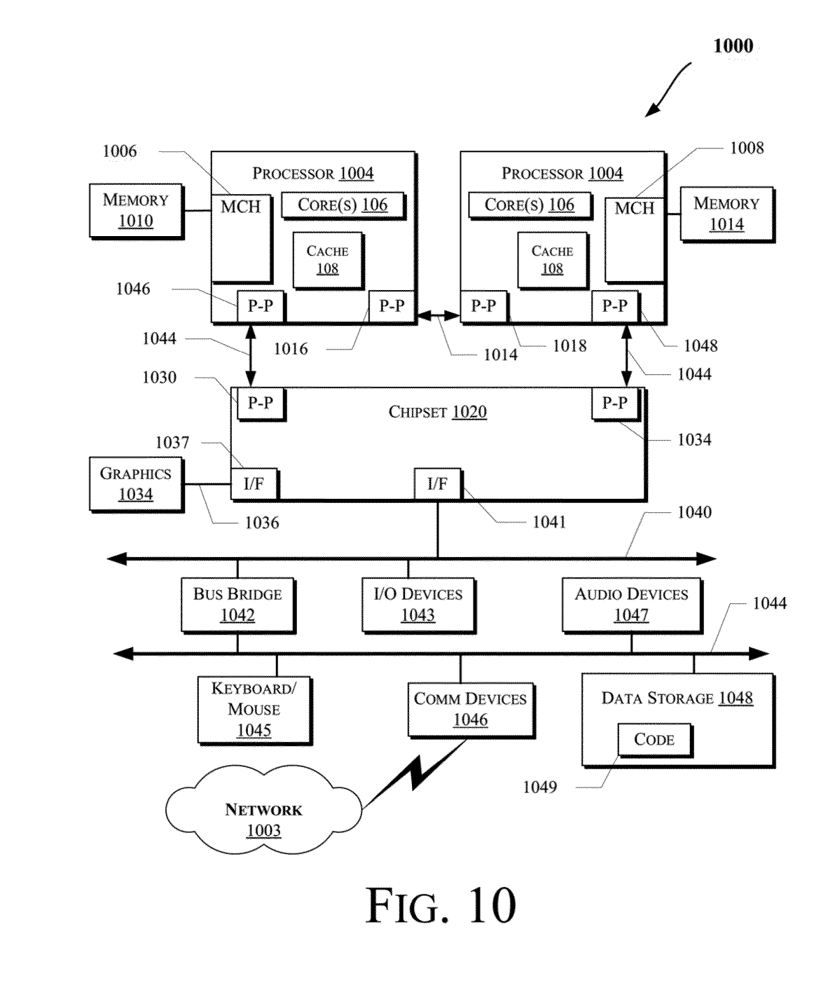

In some embodiments, one or more of the components discussed herein can be embodied as a System On Chip (SOC) device. FIG. 9 illustrates a block diagram of an SOC package in accordance with an embodiment. As illustrated in FIG. 9, SOC 902 includes one or more Central Processing Unit (CPU) cores 920, one or more Graphics Processor Unit (GPU) cores 930, an Input/Output (IO) interface 940, and a memory controller 942. Various components of the SOC package 902 may be coupled to an interconnect or bus such as discussed herein with reference to the other figures. Also, the SOC package 902 may include more or less components, such as those discussed herein with reference to the other figures. Further, each component of the SOC package 902 may include one or more other components. e.g., as discussed with reference to the other figures herein. In one embodiment. SOC package 902 (and its components) is provided on one or more Integrated Circuit (IC) die, e.g., which are packaged into a single semiconductor device.

As illustrated in FIG. 9, SOC package 902 is coupled to a memory 960 (which may be similar to or the same as memory discussed herein with reference to the other figures) via the memory controller 942. In an embodiment, the memory 960) (or a portion of it) can be integrated on the SOC package 902.

The I/O interface 940 may be coupled to one or more I/O devices 970, e.g., via an interconnect and/or bus such as discussed herein with reference to other figures. I/O device(s) 970 may include one or more of a keyboard, a mouse, a touchpad, a display, an image/video capture device (such as a camera or camcorder/video recorder), a touch screen, a speaker, or the like.

FIG. 10 illustrates a computing system 1000 that is arranged in a point-to-point (PtP) configuration, according to an embodiment of the invention. In particular. FIG. 10 shows a system where processors, memory, and input/output devices are interconnected by a number of point-to-point interfaces.

As illustrated in FIG. 10, the system 1000 may include several processors, of which only two, processors 1002 and 1004 are shown for clarity. The processors 1002 and 1004 may each include a local memory controller hub (MCH) 1006 and 1008 to enable communication with memories 1010 and 1012. MCH 1006 and 1008 may include the memory controller 120 and/or logic 125 of FIG. 1 in some embodiments.

In an embodiment, the processors 1002 and 1004 may be one of the processors 702 discussed with reference to FIG. 7. The processors 1002 and 1004 may exchange data via a point-to-point (PtP) interface 1014 using PtP interface circuits 1016 and 1018, respectively. Also, the processors 1002 and 1004 may each exchange data with a chipset 1020 via individual PtP interfaces 1022 and 1024 using point-to-point interface circuits 1026, 1028, 1030, and 1032. The chipset 1020 may further exchange data with a high-performance graphics circuit 1034 via a high-performance graphics interface 1036, e.g., using a PtP interface circuit 1037.

As shown in FIG. 10, one or more of the cores 106 and/or cache 108 of FIG. 1 may be located within the processors 1004. Other embodiments of the invention, however, may exist in other circuits, logic units, or devices within the system 1000 of FIG. 10. Furthermore, other embodiments of the invention may be distributed throughout several circuits, logic units, or devices illustrated in FIG. 10.

The chipset 1020 may communicate with a bus 1040 using a PtP interface circuit 1041. The bus 1040 may have one or more devices that communicate with it, such as a bus bridge 1042 and I/O devices 1043. Via a bus 1044, the bus bridge 1043 may communicate with other devices such as a keyboard/mouse 1045, communication devices 1046 (such as modems, network interface devices, or other communication devices that may communicate with the computer network 1003), audio I/O device, and/or a data storage device 1048. The data storage device 1048 (which may be a hard disk drive or a NAND flash based solid state drive) may store code 1049 that may be executed by the processors 1004.

The following examples pertain to further embodiments.

Example 1 is a hinge assembly 200 comprising a shaft 210, a bracket 220 to be rotatably mounted on the shaft 210, a first resistance element 230 to provide a first rotational resistance between the bracket 210 and the shaft 220 in a first angular range from a closed position, and a second resistance element 240 to provide a second rotational resistance between the bracket 220 and the shaft 210, greater than the first rotational resistance, in a second angular range, greater than the first angular range.

In Example 2, the subject matter of Example 1 can optionally include a third resistance element 250 to provide a third rotational resistance between the bracket 220 and the shaft 210, greater than the second rotational resistance, in a third angular range, greater than the second angular range.

In Example 3, the subject matter of any one of Examples 1-2 can optionally include a first friction band 232 to couple a bracket 220 to a shaft 210.

In Example 4, the subject matter of any one of Examples 1-3 can optionally include an arrangement in which the shaft 210 has a slightly variable radius in a region proximate the first friction hand 232.

In Example 5, the subject matter of any one of Examples 1-4 can optionally include an arrangement in which the first resistance element 230 comprises a second friction band 234 to couple the bracket 220 to the shaft 210.

In Example 6, the subject matter of any one of Examples 1-5 can optionally include an arrangement in which the shaft 210 has a knurled surface 212 in a region proximate the second friction band 234 and damping grease is applied to the knurled surface 212.

In Example 7, the subject matter of any one of Examples 1-6 can optionally include an arrangement in which the second resistance element 240 comprises a torsion spring 242.

In Example 8, the subject matter of any one of Examples 1-7 can optionally include a detent feature 260 rotatable about the shaft 210 and a key 270 secured in fixed relation to the shaft 210.

In Example 9, the subject matter of any one of Examples 1-8 can optionally include a key 270 rotatable about the shaft 210, and a detent feature 260 secured in fixed relation to the shaft 210.

Example 10 is a chassis for an electronic device, comprising a first section and a second section, the second section coupled to the first section by a hinge assembly, comprising a shaft 210, a bracket 220 to be rotatably mounted on the shaft 210, a first resistance element 230 to provide a first rotational resistance between the bracket 210 and the shaft 220 in a first angular range from a closed position and a second resistance element 240 to provide a second rotational resistance between the bracket 220 and the shaft 210, greater than the first rotational resistance, in a second angular range, greater than the first angular range.

In Example 11, the subject matter of Example 10 can optionally include a third resistance element 250 to provide a third rotational resistance between the bracket 220 and the shaft 210, greater than the second rotational resistance, in a third angular range, greater than the second angular range.

In Example 12, the subject matter of any one of Examples 10-11 can optionally include a first friction band 232 to couple a bracket 220 to a shaft 210.

In Example 13, the subject matter of any one of Examples 10-12 can optionally include an arrangement in which the shaft 210 has a slightly variable radius in a region proximate the first friction band 232.

In Example 14, the subject matter of any one of Examples 10-13 can optionally include an arrangement in which the first resistance element 230 comprises a second friction band 234 to couple the bracket 220 to the shaft 210.

In Example 15, the subject matter of any one of Examples 10-14 can optionally include an arrangement in which the shaft 210 has a knurled surface 212 in a region proximate the second friction band 234 and damping grease is applied to the knurled surface 212.

In Example 16, the subject matter of any one of Examples 10-15 can optionally include an arrangement in which the second resistance element 240 comprises a torsion spring 242.

In Example 17, the subject matter of any one of Examples 10-16 can optionally include a detent feature 260 rotatable about the shaft 210 and a key 270 secured in fixed relation to the shaft 210.

In Example 18, the subject matter of any one of Examples 10-17 can optionally include a key 270 rotatable about the shaft 210, and a detent feature 260 secured in fixed relation to the shaft 210.

Example 19 is an electronic device comprising at least one electronic component and a chassis comprising a first section and a second section, the second section coupled to the first section by a hinge assembly, comprising a shaft 210, a bracket 220 to be rotatably mounted on the shaft 210, a first resistance element 230 to provide a first rotational resistance between the bracket 210 and the shaft 220 in a first angular range from a closed position and a second resistance element 240 to provide a second rotational resistance between the bracket 220 and the shaft 210, greater than the first rotational resistance, in a second angular range, greater than the first angular range.

In Example 20, the subject matter of Example 19 can optionally include a third resistance element 250 to provide a third rotational resistance between the bracket 220 and the shaft 210, greater than the second rotational resistance, in a third angular range, greater than the second angular range.

In Example 21 the subject matter of any one of Examples 19-20 can optionally include a first friction band 232 to couple a bracket 220 to a shaft 210.

In Example 22, the subject matter of any one of Examples 19-21 can optionally include an arrangement in which the shaft 210 has a slightly variable radius in a region proximate the first friction band 232.

In Example 23, the subject matter of any one of Examples 19-22 can optionally include an arrangement in which the first resistance element 230 comprises a second friction band 234 to couple the bracket 220 to the shaft 210.

In Example 24, the subject matter of any one of Examples 19-23 can optionally include an arrangement in which the shaft 210 has a knurled surface 212 in a region proximate the second friction band 234 and damping grease is applied to the knurled surface 212.

In Example 25, the subject matter of any one of Examples 19-24 can optionally include an arrangement in which the second resistance element 240 comprises a torsion spring 242.

In Example 26, the subject matter of any one of Examples 19-25 can optionally include a detent feature 260 rotatable about the shaft 210 and a key 270 secured in fixed relation to the shaft 210.

In Example 27, the subject matter of any one of Examples 19-26 can optionally include a key 270 rotatable about the shaft 210, and a detent feature 260 secured in fixed relation to the shaft 210.

The terms “logic instructions” as referred to herein relates to expressions which may be understood by one or more machines for performing one or more logical operations. For example, logic instructions may comprise instructions which are interpretable by a processor compiler for executing one or more operations on one or more data objects. However, this is merely an example of machine-readable instructions and embodiments are not limited in this respect.

The terms “computer readable medium” as referred to herein relates to media capable of maintaining expressions which are perceivable by one or more machines. For example, a computer readable medium may comprise one or more storage devices for storing computer readable instructions or data. Such storage devices may comprise storage media such as, for example, optical, magnetic or semiconductor storage media. However, this is merely an example of a computer readable medium and embodiments are not limited in this respect.

The term “logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a memory in combination with processing circuitry to execute such machine-readable instructions. However, these are merely examples of structures which may provide logic and embodiments are not limited in this respect.

Some of the methods described herein may be embodied as logic instructions on a computer-readable medium. When executed on a processor, the logic instructions cause a processor to be programmed as a special-purpose machine that implements the described methods. The processor, when configured by the logic instructions to execute the methods described herein, constitutes structure for performing the described methods. Alternatively, the methods described herein may be reduced to logic on, e.g., a field programmable gate array (FPGA), an application specific integrated circuit (ASIC) or the like.

In the description and claims, the terms coupled and connected, along with their derivatives, may be used. In particular embodiments, connected may be used to indicate that two or more elements are in direct physical or electrical contact with each other. Coupled may mean that two or more elements are in direct physical or electrical contact. However, coupled may also mean that two or more elements may not be in direct contact with each other, but yet may still cooperate or interact with each other.

Reference in the specification to “one embodiment” or “some embodiments” means that a particular feature, structure, or characteristic described in connection with the embodxliment is included in at least an implementation. The appearances of the phrase “in one embodiment” in various places in the specification may or may not be all referring to the same embodiment.

Although embodiments have been described in language specific to structural features and/or methodological acts, it is to be understood that claimed subject matter may not be limited to the specific features or acts described. Rather, the specific features and acts are disclosed as sample forms of implementing the claimed subject matter.

1-25. (canceled)

26. A hinge assembly, comprising:
a shaft;
a bracket to be rotatably mounted on the shaft;
a first resistance element to provide a first rotational resistance between the bracket and the shaft in a first angular range from a closed position; and
a second resistance element to provide a second rotational resistance between the bracket and the shaft, greater than the first rotational resistance, in a second angular range, greater than the first angular range.

27. The hinge assembly of claim 26, further comprising a third resistance element to provide a third rotational resistance between the bracket and the shaft, greater than the second rotational resistance, in a third angular range, greater than the second angular range.

28. The hinge assembly of claim 26, wherein the first resistance element comprises a first friction band to couple a bracket to a shaft.

29. The hinge assembly of claim 28, wherein:
the shaft has a slightly variable radius in a region proximate the first friction band.

30. The hinge assembly of claim 28, wherein first resistance element comprises a second friction band to couple the bracket to the shaft.

31. The hinge assembly of claim 30, wherein:
the shaft has a knurled surface in a region proximate the second friction band; and
damping grease is applied to the knurled surface.

32. The hinge assembly of claim 26, wherein the second resistance element comprises a torsion spring.

33. The hinge assembly of claim 26, further comprising:
a detent feature rotatable about the shaft; and
a key secured in fixed relation to the shaft.

34. The hinge assembly of claim 26, further comprising:
a key rotatable about the shaft; and
a detent feature secured in fixed relation to the shaft.

35. A chassis for an electronic device, comprising:
a first section and a second section, the second section coupled to the first section by a hinge assembly, comprising:
a shaft;
a bracket to be rotatably mounted on the shaft;
a first resistance element to provide a first rotational resistance between the bracket and the shaft in a first angular range from a closed position; and
a second resistance element to provide a second rotational resistance between the bracket and the shaft, greater than the first rotational resistance, in a second angular range, greater than the first angular range.

36. The chassis of claim 35, further comprising a third resistance element to provide a third rotational resistance between the bracket and the shaft, greater than the second rotational resistance, in a third angular range, greater than the second angular range.

37. The chassis of claim 35, wherein the first resistance element comprises a first friction band to couple a bracket to a shaft.

38. The chassis of claim 37, wherein:
the shaft has a slightly variable radius in a region proximate the first friction band.

39. The chassis of claim 37, wherein first resistance element comprises a second friction band to couple the bracket to the shaft.

40. The chassis of claim 39, wherein:
the shaft has a knurled surface in a region proximate the second friction band; and
damping grease is applied to the knurled surface.

41. The chassis of claim 35, wherein the second resistance element comprises a torsion spring.

42. The chassis of claim 35, further comprising:
a detent feature rotatable about the shaft; and
a key secured in fixed relation to the shaft.

43. The chassis of claim 35, further comprising:
a key rotatable about the shaft; and
a detent feature secured in fixed relation to the shaft.

44. An electronic device, comprising:
at least one electronic component; and
a chassis comprising a first section and a second section, the second section coupled to the first section by a hinge assembly, comprising:
a shaft;
a bracket to be rotatably mounted on the shaft;
a first resistance element to provide a first rotational resistance between the bracket and the shaft in a first angular range from a closed position; and
a second resistance element to provide a second rotational resistance between the bracket and the shaft, greater than the first rotational resistance, in a second angular range, greater than the first angular range.

45. The electronic device of claim 44, further comprising a third resistance element to provide a third rotational resistance between the bracket and the shaft, greater than the second rotational resistance, in a third angular range, greater than the second angular range.

46. The electronic device of claim 44, wherein the first resistance element comprises a first friction band to couple a bracket to a shaft.

47. The electronic device of claim 46, wherein:
the shaft has a slightly variable radius in a region proximate the first friction band.

48. The electronic device of claim 46, wherein first resistance element comprises a second friction band to couple the bracket to the shaft.

49. The electronic device of claim 48, wherein:
the shaft has a knurled surface in a region proximate the second friction band; and
damping grease is applied to the knurled surface.

50. The electronic device of claim 44, wherein the second resistance element comprises a torsion spring.
